(19) United States
(12) Patent Application Publication
(10) Pub. No.: US 2011/0230148 A1
(43) Pub. Date: Sep. 22, 2011

(54) Wearable Electronic Devices with Electro-Mechanical Retention Portion and Related Systems and Methods

(76) Inventors: Randolph Cary Demuynck, Wake Forest, NC (US); Bart P. Reier, Cary, NC (US); Curtis W. Thornton, Pittsboro, NC (US)

(21) Appl. No.: 12/727,440

(22) Filed: Mar. 19, 2010

(51) Int. Cl. H04B 1/38

(52) U.S. Cl. 455/90.3

(57) ABSTRACT

A wearable mobile terminal that is configured to provide communications is provided. The wearable mobile terminal includes a primary housing that is configured to include a first portion of a plurality of electronic mobile terminal components therein and a retention member including a proximal end that is attached to a first side of the primary housing and a distal end that is biased towards the first side of the primary housing, the retention member including a second portion of the plurality of electronic mobile terminal components therein, the retention member configured to retain the wearable mobile terminal in a location proximate a user of the wearable mobile terminal.

### FIELD

The present invention relates to portable electronic devices, and, more particularly, to wearable portable electronic devices and associated methods.

### BACKGROUND

Portable electronic devices, such as mobile terminals, are commonplace in today's society. People use portable devices everywhere, such as their homes, offices, cars and the like. Portable electronic devices that may be worn attached to an article of clothing may be desirable corresponding to some occasions and/or activities. In this regard, a mechanical retention component for engaging the article of clothing may be provided. For example, reference is made to FIGS. 1A and 1B, which are block diagrams of conventional portable electronic devices including retention components in a closed and an open position, respectively. Such portable electronic devices 10 may include a housing 12 that contains the electronic components that provide the functionality thereof. A mechanical retention component 14 may be movably and/or flexibly attached to the housing 12 via an attaching member 16. The position of the mechanical retention component 14 may be changed relative to the housing 12 to receive an article of clothing.

### SUMMARY OF THE INVENTION

Some embodiments of the present invention provide a wearable mobile terminal configured to provide communications. The wearable mobile terminal may include a primary housing that is configured to include a first portion of electronic mobile terminal components therein. A retention member may include a proximal end that is attached to a first side of the primary housing and a distal end that is biased towards the first side of the primary housing. The retention member may include a second portion of the electronic mobile terminal components therein and may be configured to retain the wearable mobile terminal in a location proximate a user of the wearable mobile terminal.

Some embodiments provide that at least one of the first portion of electronic mobile terminal components is electrically coupled to at least one of the second portion of electronic mobile terminal components. Some embodiments may include an interconnection component that is configured to electrically couple at least one of the first portion of electronic mobile terminal components to at least one of the second portion of electronic mobile terminal components. A biasing element that is proximate the proximal end of the retention member may be provided. The interconnection component may be proximate the biasing element and may be configured to maintain the electrical coupling independent of a position of the retention member to the primary housing.

In some embodiments, the proximal end of the retention member is rotatably attached to the first side of the primary housing. The distal end of the retention member and the first side of the primary housing may be configured to frictionally engage an article of clothing that is configured to be worn by the user of the wearable mobile terminal.

Some embodiments provide that the first portion of electronic mobile terminal components includes a transceiver that is configured to provide wireless communications, an antenna that is coupled to the transceiver and a audio input component that is configured to receive an audible signal. In some embodiments, the second portion of electronic mobile terminal components includes at least one output device that is configured to communicate information to the user of the wearable mobile terminal. Some embodiments provide that the output device may include a speaker that is configured to transmit audible information to the user and/or a tactile output device that is configured to provide a vibratory output to the user.

Some embodiments may include an identifier module interface that is configured to receive an identifier module that includes subscriber account identification data. Some embodiments provide that the identifier module interface is on a first side of the retention member and that the first side of the retention member is configured to engage the first side of the primary housing. In this manner, the identifier module interface may be accessible to the user when the retention member is rotated away from the primary housing.

Further embodiments may include a removable memory interface that may be on the first side of the retention member. The removable memory interface may be configured to receive and conductively engage a removable memory module. In some embodiments, the first side of the retention member is configured to engage the first side of the primary housing and is configured to be accessible to the user when the distal end of the retention member is rotated away from the primary housing to increase a gap between the distal end of the retention member and the first side of the primary housing and substantially concealed when the distal end of the retention member is in a rotated towards the primary housing to engage the first side of the primary housing and/or an article placed therebetween.

Some embodiments include a data connector interface that is on the first side of the primary housing and that is configured to receive a data connector corresponding to an external data device. In some embodiments, the data connector interface is further configured to receive an electrical current to charge an on-board battery.

The wearable mobile terminal may include a reset switch that is configured to receive a user input that causes a switch output to change from a first state to a second state that is different from the first state. In response to the second state of the switch output, the wearable mobile terminal may be operable to perform a device reset operation.

Some embodiments of the present invention may include a retention member for a wearable portable electronic device that includes multiple electronic components. The wearable portable electronic device may include a primary housing that includes a first portion of the electronic components. The retention member may include a second portion of the electronic components. Some embodiments provide that at least one of the second portion of electronic components is electrically connected to at least one of the first portion of electronic components. The retention member may include an attaching structure that is configured to movably attach the retention member to the primary housing structure.

Some embodiments provide that the attaching structure is further configured to rotatably attach a proximal end of the retention member to the primary housing. A distal end of the retention member may be configured to engage an attachment article on a user of the wearable portable electronic device to retain the portable electronic device proximate the attachment article. The attaching structure may include a biasing element that is configured to bias the distal end of the retention member towards the primary housing.

The retention member may include an identifier module interface that is configured to receive an identifier module that includes subscriber account identification data. The identifier module interface may be on a first side of the retention member that may be configured to engage the first side of the primary housing. The identifier module interface may be configured to be accessible to the user when the retention member is rotated away from the primary housing.

Further embodiments of the retention member may include a reset switch that is configured to receive a user input that causes a switch output to change from a first state to a second state that is different from the first state. The wearable portable electronic device may be operable to perform a device reset operation responsive to the second state of the switch output.

Some embodiments of the present invention include methods of operating a wearable mobile terminal that may include a primary housing and a retention member that is configured to removably attach the wearable mobile terminal to a user attachment article. Methods may include moving a distal end of the retention member relative to a first surface of the primary housing to increase a gap therebetween via a rotatable attachment between a proximal end of the retention member and the first side of the primary housing. A first electronic interface that corresponds to a first portion of mobile terminal electronics in the retention member may be accessed. The first electronic interface may be accessible via the gap between the distal end of the retention member and the first side of the primary housing.

Some embodiments include accessing a second electronic interface that corresponds to a second portion of mobile terminal electronics in the primary housing. The second electronic interface may be accessible via the gap between the distal end of the retention member and the first side of the primary housing. In some embodiments, the wearable mobile terminal may be removably attached to the user attachment article via a frictional engagement between the distal end of the retention member and the first surface of the primary housing.

### BRIEF DESCRIPTION OF THE DRAWINGS

FIGS. 1A and 1B are block diagrams of conventional portable electronic devices including mechanical retention components in a closed and open position, respectively.

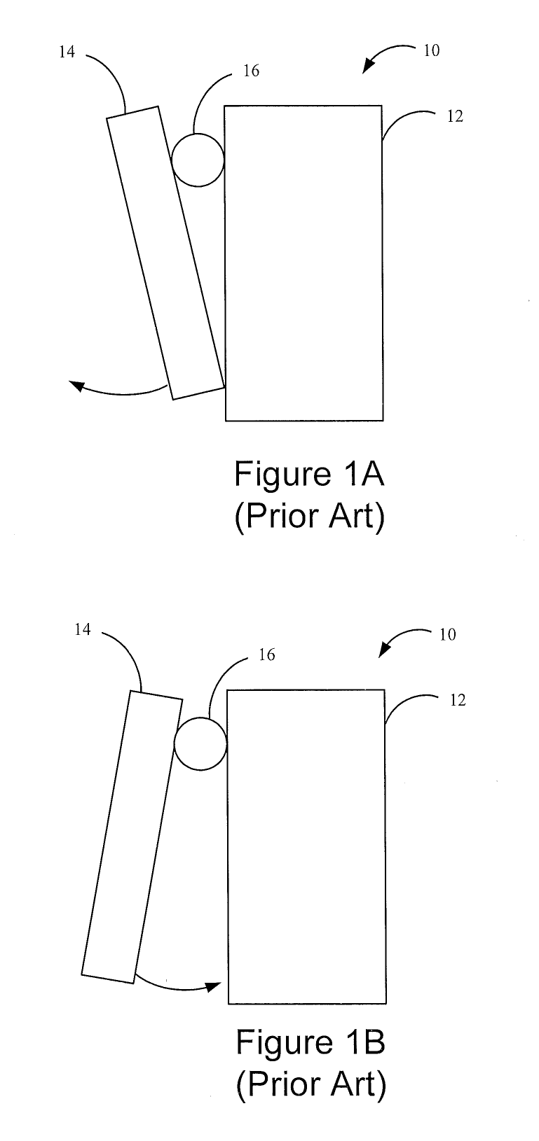

FIGS. 2A and 2B are block diagrams each illustrating a wearable mobile terminal including an electro-mechanical retention component in a closed and open position, respectively, according to some embodiments of the present invention.

FIG. 3 is a schematic block diagram illustrating a wearable mobile terminal including an electro-mechanical retention component and exemplary functional components therein according to some embodiments of the present invention.

FIG. 4 is a flow diagram illustrating operations for operating a wearable mobile terminal according to some embodiments of the present invention.

### DETAILED DESCRIPTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Some embodiments are described with regard to flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Conventional portable devices may include, mobile communication terminals, such as cellular telephones. When such mobile terminals are to be worn by a user, a desirable feature may be a reduced overall size of the device to provide optimal comfort and convenience. Additionally, when devices that are configured to transmit electromagnetic radiation, such as mobile communication terminals, are placed proximate a user, potential health related issues may be a consideration. For example, a specific absorption rate (SAR), which is a measure of the rate at which energy is absorbed by the body when exposed to a radio frequency electromagnetic field, may provide indications regarding a minimum spacing distance between transmitting elements in mobile terminals and a user. Accordingly, merely attaching a flip style terminal to, for example, a pocket, may result undesirable SAR related issues and/or not comply with minimum spacing requirements. In this regard, in addition to reduced size, wearable mobile terminals described herein also are in compliance with minimum spacing requirements for such devices by virtue of the electro-mechanical retention member disclosed herein. Some embodiments provide that wearable mobile terminals as described herein may be selectively used as an alternative to full-function mobile terminals, such as, for example, smart phones and/or personal digital assistants, among others.

For purposes of illustration and explanation only, various embodiments of the present invention are described herein in the context of wearable mobile communication terminals (“wireless terminals” or “terminals”) that are configured to communicate through a cellular communication interface (e.g., cellular voice and/or data communications) and to communicate through a wireless local area network (WLAN) interface and Bluetooth wireless interface. It will be understood, however, that the present invention is not limited to such embodiments and may be embodied generally in any wearable mobile communication terminal.

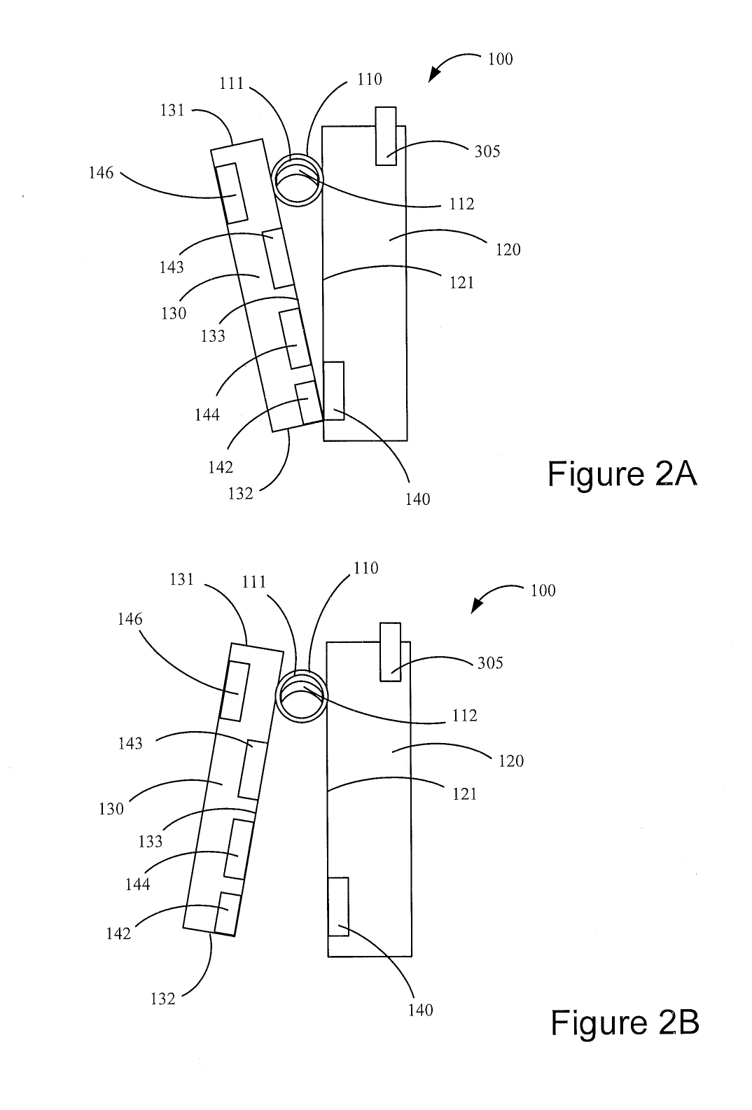

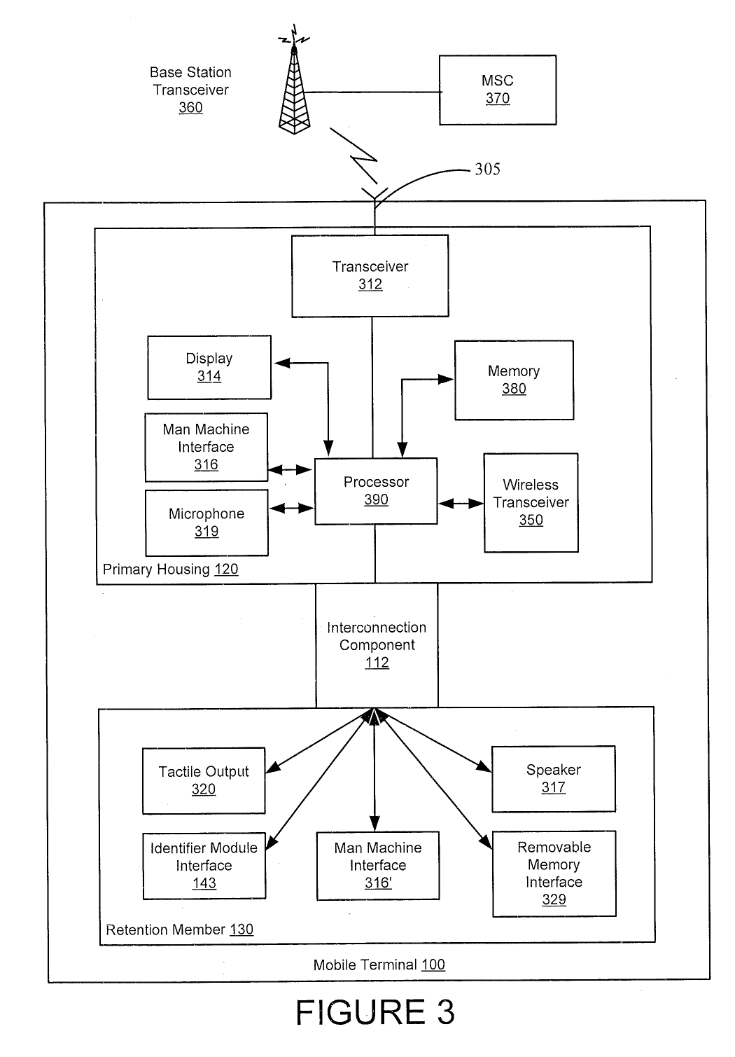

Reference is now made to FIGS. 2A and 2B, which are block diagrams each illustrating a wearable mobile terminal including an electro-mechanical retention component in a closed and open position, respectively, according to some embodiments of the present invention. The wearable mobile terminal 100 includes a primary housing 120 that is configured to contain and/or support substantive portions of the electronics corresponding to the functionality of the terminal 100, as discussed in detail below regarding FIG. 3. The primary housing 120 may include an antenna 305 and/or other transmitting/receiving components, as discussed below in detail. Some embodiments provide that transmitting and/or receiving components are exclusively included in the primary housing 120 to accomplish SAR-related design goals.

A retention member 130 may be movably engaged with the primary housing 120. Some embodiments provide that the retention member 130 is rotatably engaged with the primary housing 120. For example, the retention member 130 may include a proximal end 131 and a distal end 132 that is opposite the proximal end 131. The proximal end 131 may be attached to a first side 121 of the primary housing 120 via an attaching structure 110. In some embodiments, the attaching structure 110 may include and/or coordinate with a biasing element 111 that is configured to bias or urge the distal end 132 of the retention member 130 towards the first face 121 of the primary housing 120. Some embodiments provide that the attaching structure 110 is configured to rotatably attach the proximal end 131 of the retention member 130 to the primary housing 120. The distal end 132 of the retention member 130 may engage an attachment article on a user of the wearable portable electronic device 100 to retain the wearable portable electronic device 100 proximate the attachment article. As used herein, the term “attachment article” refers to any clothing, clothing accessory and/or other personal article that a user may maintain in proximity thereof and use to attach the wearable mobile terminal thereto.

An interconnection component 112 may electrically couple at least one of the electrical components in the retention member 130 to at least one of the electrical components in the primary housing 120. In some embodiments, the interconnection element 112 may include one or more flexible conductors and/or multiple conductor components. Some embodiments provide that the interconnection component 112 may include pins, rings, and/or movable contacts, among others. The interconnection component 112 may be configured to maintain the electrical connections through a full range of motion of the retention member 130 relative to the primary housing 120. Some embodiments provide that the interconnection component 112 may include multiple electrically conductive paths including 4, 8, 16, 24, 32, and 64 different electrically conductive paths, among others.

In addition to a portion of the electronic components of the wearable mobile terminal 100, some embodiments of the retention member 130 may include a removable memory interface 144 that is configured to receive and conductively engage a removable memory module, connector and/or device. Some embodiments provide that the removable memory interface 144 is on a first side 133 of the retention member 130. In this manner, when the retention member 130 is in a substantially closed position, accessibility to the removable memory interface 144 may be reduced and/or eliminated. The retention member 130 may be rotated to increase a gap between the distal end 132 and the primary housing 120 in order to access the removable memory interface 144. Some embodiments provide that the removable memory interface 144 is configured to be below a surface of the first side 133 of the retention member 130 to protect a memory module that is inserted therein from contact related damage.

In addition to a portion of the electronic components of the wearable mobile terminal 100, some embodiments of the retention member 130 may include an identifier module interface 143 that is configured to receive and conductively engage an identifier module that includes subscriber account identification data. A non-limiting example of an identifier module may include a subscriber identification module (SIM) card, but the invention is not so limited. Some embodiments provide that the identifier module interface 143 is on the first side 133 of the retention member 130. In this manner, when the retention member 130 is in a substantially closed position, accessibility to the identifier module interface 143 may be reduced and/or eliminated. The retention member 130 may be rotated to increase a gap between the distal end 132 and the primary housing 120 in order to access the identifier module interface 143. Some embodiments provide that the identifier module interface 143 is configured to be below a surface of the first side 133 of the retention member 130 to protect an identifier module that is inserted therein from contact damage. Although as illustrated, the identifier module interface 143 may be in the retention member 130, the invention is not so limited. For example, some embodiments provide that the identifier module interface 143 may be configured in the primary housing 120.

A reset switch 142 may be provided to receive a user input that causes the reset switch 142 to change from a first output state to a second output state. The wearable mobile terminal 100 may be configured to perform a device reset operation responsive to the second output state of the reset switch 142. Some embodiments provide that the reset switch 142 is a momentary-on button, slide switch, rocker switch and/or biased contact switch, among others. In some embodiments, the reset switch 142 is recessed to avoid inadvertent contact therewith. For example, the reset switch 142 may be positioned below a position of a removable memory module and/or identifier module. In this regard, the removable memory module and/or identifier module may cover the reset switch 142 when installed. Although as illustrated, the reset switch 142 may be in the retention member 130, the invention is not so limited. For example, some embodiments provide that the reset switch 142 may be configured in the primary housing 120.

A data connector interface 140 may be provided to receive a data connector corresponding to an external device. The data connector interface 140 may be configured to receive data connectors corresponding to multiple types of data connectors that are operable to transmit and/or receive data using any of a variety of data communication protocols. For example, the data connector interface 140 may support Universal Serial Bus (USB), serial, parallel, etc. Some embodiments provide that the data connector interface 140 is configured to receive an electrical current to charge a battery that may be in the retention member 130 and/or the primary housing 120. Although as illustrated, the data connector interface 140 may be in the primary housing 120, the invention is not so limited. For example, some embodiments provide that the data connector interface 140 may be configured in the retention member 130. As illustrated in FIG. 2A, when the retention member 130 is in a closed position relative to the primary housing 120, the data connector interface 140 may be hidden, protected and/or inaccessible.

One or more output devices 146 may be included in the wearable mobile terminal 100 to communicate information to the user. In some embodiments, an output device 146 may include a speaker and/or a tactile output device and may be included in the retention member 130 and/or the primary housing 120. A tactile output device may include, for example, a vibrator that is configured to provide a motion output that can be perceived by a user. In some embodiments, an output device 146 may include one or more light emitting elements that are configured to be energized to provide a visible communication to a user. By including portions of the electronic mobile terminal components in the retention member 130, the primary housing 120 may be beneficially reduced in size. Additionally, the retention member 130 may provide spacing that might be unavailable due to the reduced size of the primary housing, which in isolation might result in undesirable levels of received electromagnetic radiation.

Reference is now made to FIG. 3, which is a schematic block diagram illustrating a wearable mobile terminal including an electro-mechanical retention component and exemplary functional components therein according to some embodiments of the present invention. As used herein, the term “wearable mobile terminal” includes, but is not limited to: a cellular radiotelephone with or without a multi-line display; a Personal Communications System (PCS) terminal that combines a cellular radiotelephone with data processing, facsimile and data communications capabilities; a Personal Data Assistant (PDA) that includes a radiotelephone, pager, Internet/intranet access, Web browser, organizer, calendar and/or a global positioning system (GPS) receiver; a gaming device, an audio video player, and a conventional laptop and/or palmtop portable computer that includes a radiotelephone transceiver and that can be worn by a user. Any portable electronic device capable of operating in accordance with some embodiments of the present invention may be used without departing from the scope of the present invention.

As illustrated in FIG. 3, the wearable mobile terminal 100 includes a primary housing 120, a retention member 130 and an interconnection component 112. The primary housing 120 may include a display 314, a man machine interface (MMI) 316, a microphone 319, a transceiver 312, a memory 380 and a wireless transceiver 350, any of which may communicate with a processor 390. The wireless transceiver 350 may support short range wireless communication such as Bluetooth, WLAN and Wi-Fi without departing from the scope of the present invention. It will be understood that the wireless transceiver 350 and the transceiver 312 may be combined without departing from the scope of the present invention. The processor 390 can be any commercially available and/or custom microprocessor.

The retention member 130 may include a speaker 317, a tactile output 321, an identifier module interface 143, a removable memory interface 144, a speaker 317 and a MMI 316′.

The MMI 316 and/or 316′ may provide an operating interface for the user to access the functionality of the wearable mobile terminal 100. In some embodiments, the MMI 316/316′ may include, in conjunction with the processor 390, voice activated functionality, including, for example, answering and/or initiating a call from the wearable mobile terminal 100 using voice commands.

As illustrated in FIG. 3, the wearable mobile terminal 100 communicates with a base station transceiver 360 connected to a mobile switching center (“MSC”) 370 in accordance with some embodiments of the present invention. The transceiver 312 typically includes a transmitter circuit and a receiver circuit, which respectively transmit outgoing radio frequency signals to the base station transceiver 360 and receive incoming radio frequency signals, such as voice and data signals, from the base station transceiver 360 via an antenna 305. The antenna 305 may be an embedded antenna, a retractable antenna or any antenna known to those having skill in the art without departing from the scope of the present invention. The radio frequency signals transmitted between the portable electronic device 340 and the base station transceiver 360 may include both traffic and control signals (e.g., paging signals/messages for incoming calls), which are used to establish and maintain communication with another party or destination. By including a portion of the electronics in the retention member 130, the size of the primary housing 120 may be reduced to dimensions that were previously unavailable due to SAR-related issues. The processor 390 may support various functions of the portable electronic device, including a wireless transceiver configured to communicate with a wireless device, such as, for example, a headset.

It will be understood that in some embodiments of the present invention, the transceiver 312 may be a short range transceiver. The short range transceiver may be, for example, a Bluetooth transceiver, which may allow for high transfer rates of data over relatively short distances. It will be further understood that wearable mobile terminals 100 according to some embodiments of the present invention may include a wireless transceiver and a short range transceiver/transmitter as discussed above.

In some embodiments of the present invention, the base station transceiver 360 comprises the radio transceiver(s) that defines an individual cell in a cellular network and communicates with the wearable mobile terminal 100 and other portable electronic devices in the cell using a radio-link protocol. Although only a single base station transceiver 360 is shown, it will be understood that many base station transceivers may be connected through, for example, a mobile switching center 370 and other devices to define a wireless communications network.

The interconnection component 112 may include flexible conductors and/or groups thereof, pins, contacts and/or other electrical connection technologies that provide uninterrupted electrical conduction of multiple signal paths between at least one of the retention member 130 electronic components and at least one of the primary housing 120 electronic components as the retention member 130 is moved relative to the primary housing 120. In some embodiments, the interconnection component 112 may be configured as a data bus between electronic components in the primary housing 120 and electronic components in the retention member 130.

The processor 390 may include a general purpose processor circuit and/or a digital signal processor circuit, which can execute instructions from a computer readable memory that may reside therein or may be connected thereto, to perform at least some of the operations and methods described herein.

The transceiver 312 can be configured to encode/decode and transmit and receive RF communications according to one or more cellular protocols, which may include, but are not limited to, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS), WiMAX, and/or Long Term Evolution (LTE).

The processor 390 may include an alert generator that is configured to trigger the tactile output 320 and/or the speaker 317 in response to the terminal 100 receiving a message, such as a call paging message and/or a text/multimedia message, through the transceiver 312 and/or the wireless transceiver 350. Some embodiments provide that the tactile output 320 may include a vibration device that is configured to provide a motion output via the terminal 100.

The functionality of the wearable mobile terminal 100 may include, for example, a change in volume to the speaker 317, initiation of a call received by the wearable mobile terminal 100, termination of a call received by the wearable mobile terminal 100 and/or muting the speaker 317. Although some embodiments described herein provide that specific electronic components and/or functions are in the primary housing 120 or the retention member 130, such descriptions are merely exemplary as many of the different electronic components and/or functions may be configured in the primary housing 120 and/or the retention member 130.

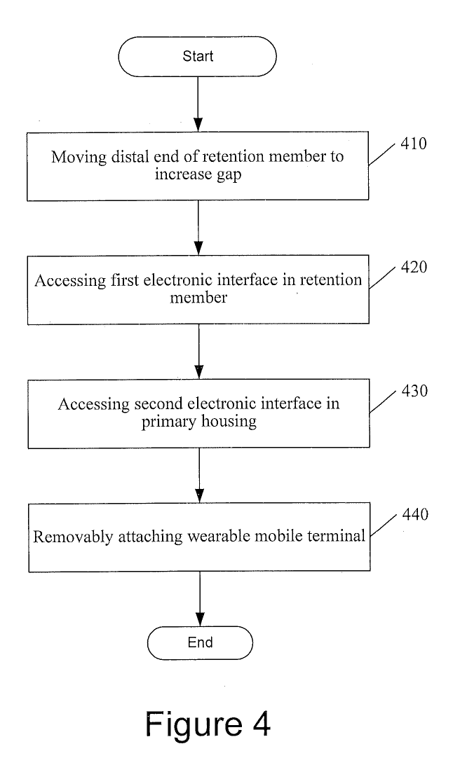

Reference is now made to FIG. 4, which is a flow diagram illustrating operations for operating a wearable mobile terminal according to some embodiments of the present invention. A distal end of the retention member is moved relative to a first surface of the primary housing to increase a gap therebetween (block 410). The movement may be performed via a rotatable attachment between a proximal end of the retention member and the first side of the primary housing. A first electronic interface in the retention member may be accessed (block 420). The first electronic interface may correspond to a first portion of mobile terminal electronics in the retention member and may be accessible via the gap between the distal end of the retention member and the first side of the primary housing.

In some embodiments, a second electronic interface that is in the primary housing may be accessed (block 430). The second electronic interface may correspond to a second portion of mobile terminal electronics in the primary housing. Some embodiments provide that the second electronic interface is accessible via the gap between the distal end of the retention member and the first side of the primary housing.

In some embodiments, the wearable mobile terminal may be removably attached to the user attachment article (block 440). For example the wearable mobile terminal may be attached via a frictional engagement between the distal end of the retention member and the first surface of the primary housing that may be maintained by a biasing element.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A wearable mobile terminal configured to provide communications, the wearable mobile terminal comprising:
a primary housing that is configured to include a first portion of a plurality of electronic mobile terminal components therein; and
a retention member including a proximal end that is attached to a first side of the primary housing and a distal end that is biased towards the first side of the primary housing, the retention member including a second portion of the plurality of electronic mobile terminal components therein, the retention member configured to retain the wearable mobile terminal in a location proximate a user of the wearable mobile terminal.

2. The wearable mobile terminal of claim 1, wherein at least one of the first portion of the plurality of electronic mobile terminal components is electrically coupled to at least one of the second portion of the plurality of electronic mobile terminal components.

3. The wearable mobile terminal of claim 2, further comprising an interconnection component that is configured to electrically couple the at least one of the first portion of the plurality of electronic mobile terminal components to the at least one of the second portion of the plurality of electronic mobile terminal components.

4. The wearable mobile terminal of claim 3, further comprising a biasing element that is proximate the proximal end of the retention member, wherein the interconnection component is proximate the biasing element and is configured to maintain the electrical coupling independent of a position of the retention member to the primary housing.

5. The wearable mobile terminal of claim 1, wherein the proximal end of the retention member is rotatably attached to the first side of the primary housing, and wherein the distal end of the retention member and the first side of the primary housing are configured to frictionally engage an article of clothing that is configured to be worn by the user of the wearable mobile terminal.

6. The wearable mobile terminal of claim 1,
wherein the first portion of the plurality of electronic mobile terminal components comprises a transceiver that is configured to provide wireless communications, an antenna that is coupled to the transceiver and a audio input component that is configured to receive an audible signal.

7. The wearable mobile terminal of claim 6,
wherein the second portion of the plurality of electronic mobile terminal components comprises at least one output device that is configured to communicate information to the user of the wearable mobile terminal.

8. The wearable mobile terminal of claim 7, wherein the at least one output device comprises a speaker that is configured to transmit audible information to the user and/or a tactile output device that is configured to provide a vibratory output to the user.

9. The wearable mobile terminal of claim 1, further comprising an identifier module interface that is configured to receive an identifier module that includes subscriber account identification data, wherein the identifier module interface is on a first side of the retention member, wherein the first side of the retention member is configured to engage the first side of the primary housing and is configured to be accessible to the user when the retention member is rotated away from the primary housing.

10. The wearable mobile terminal of claim 1, further comprising a removable memory interface that is on a first side of the retention member and that is configured to receive and conductively engage a removable memory module,
wherein the first side of the retention member is configured to engage the first side of the primary housing and is configured to be accessible to the user when the distal end of the retention member is rotated away from the primary housing to increase a gap between the distal end of the retention member and the first side of the primary housing and substantially concealed when the distal end of the retention member is in a rotated towards the primary housing to engage the first side of the primary housing and/or an article placed therebetween.

11. The wearable mobile terminal of claim 1, further comprising a data connector interface that is on the first side of the primary housing and that is configured to receive a data connector corresponding to an external data device,
wherein the first side of the primary housing is configured to engage a first side of the primary housing and is configured to be accessible to the user when the distal end of the retention member is rotated away from the primary housing to increase a gap therebetween.

12. The wearable mobile terminal of claim 11, wherein the data connector interface is further configured to receive an electrical current to charge an on-board battery.

13. The wearable mobile terminal of claim 1, further comprising a reset switch that is configured to receive a user input that causes a switch output to change from a first state to a second state that is different from the first state,
wherein the wearable mobile terminal is operable to perform a device reset operation responsive to the second state of the switch output.

14. A retention member for a wearable portable electronic device that includes a plurality of electronic components and a primary housing that includes a first portion of the plurality of electronic components, the retention member comprising:
a second portion of the plurality of electronic components, at least one of which is electrically connected to at least one of the first portion of the plurality of electronic components; and
an attaching structure that is configured to movably attach the retention member to the primary housing structure.

15. The retention member of claim 14,
wherein the attaching structure is further configured to rotatably attach a proximal end of the retention member to the primary housing,
wherein a distal end of the retention member is configured to engage an attachment article on a user of the wearable portable electronic device to retain the portable electronic device proximate the attachment article, and
wherein the attaching structure comprises a biasing element that is configured to bias the distal end of the retention member towards the primary housing.

16. The retention member of claim 14, further comprising an identifier module interface that is configured to receive an identifier module that includes subscriber account identification data,
wherein the identifier module interface is on a first side of the retention member, and
wherein the first side of the retention member is configured to engage the first side of the primary housing and is configured to be accessible to the user when the retention member is rotated away from the primary housing.

17. The retention member of claim 14, further comprising a reset switch that is configured to receive a user input that causes a switch output to change from a first state to a second state that is different from the first state,
wherein the wearable portable electronic device is operable to perform a device reset operation responsive to the second state of the input component output.

18. A method of operating a wearable mobile terminal, the wearable mobile terminal including a primary housing and a retention member that is configured to removably attach the wearable mobile terminal to a user attachment article, the method comprising:
moving a distal end of the retention member relative to a first surface of the primary housing to increase a gap therebetween via a rotatable attachment between a proximal end of the retention member and the first side of the primary housing; and
accessing a first electronic interface that corresponds to a first portion of mobile terminal electronics in the retention member, the first electronic interface being accessible via the gap between the distal end of the retention member and the first side of the primary housing.

19. The method of claim 18, further comprising accessing a second electronic interface that corresponds to a second portion of mobile terminal electronics in the primary housing, the second electronic interface being accessible via the gap between the distal end of the retention member and the first side of the primary housing.

20. The method of claim 18, further comprising removably attaching the wearable mobile terminal to the user attachment article via a frictional engagement between the distal end of the retention member and the first surface of the primary housing.
